(19) United States
(12) Patent Application Publication
(10) Pub. No.: US 2022/0186615 A1
(43) Pub. Date: Jun. 16, 2022

(54) A METHOD FOR UPSCALING OF RELATIVE PERMEABILITY OF THE PHASE OF A FLUID

(71) Applicant: TOTALENERGIES SE, Courbevoie (FR)

(72) Inventor: Gérard MASSONNAT, Pau (FR)

(21) Appl. No.: 17/603,306

(22) PCT Filed: Apr. 16, 2019
(86) PCT No.: PCT/IB2019/000533

§ 371 Date: Oct. 12, 2021

(51) Int. Cl. E21B 49/00

(52) U.S. Cl. CPC E21B 49/003; E21B 2200/20

(57) ABSTRACT

The invention relates to a method for upscaling data of a reservoir model, the method being implemented by a computer, and comprising the steps of: —defining a reservoir model comprising a volume of dimensions D_{H}, Dᵥ along respectively two distinct directions H,V, —receiving statistical data relative to the volume, comprising: relative proportions of at least two rock types, wherein each rock type corresponds to a permeability value and respective curves of relative permeability with water saturation of two phases of a fluid within the rock type, one of the phases being water, and a variogram of absolute permeability defined by correlation lengths L_{H}, Lᵥ, along the two directions H,V, and, —computing, equivalent relative permeability values of a phase of the fluid within the volume, comprising: at least an equivalent relative permeability value according to the first direction H, and at least an equivalent relative permeability value according to the second direction V, wherein each equivalent relative permeability value of a phase of the fluid according to a direction d chosen among H,V is computed based on relative permeability values of the phase of the fluid within each rock type, and on a coefficient depending on the anisotropy of the volume and on non-ergodicity parameters ε_{H}, εᵥ relative to each direction H,V, the non-ergodicity parameters depending on the volume dimensions along said directions and on the variogram of absolute permeability.

### FIELD OF THE INVENTION

The invention relates to a method for upscaling hydrocarbon reservoir model data, and in particular for upscaling relative permeability of a phase of a fluid comprising two phases.

### TECHNICAL BACKGROUND

Economic challenges related to the oil industry require the possibility of describing realistically the geological structure of hydrocarbon reservoirs and the properties of the rocks which make them up.

By reservoir, is meant a sufficiently porous and permeable rock for it to be able to contain fluids (water, oil, gas). These rocks (limestones, dolomites, sandstones) are of economic interest if their volumes are sufficient and if they are covered by impermeable layers preventing the fluid from escaping. A reservoir for example is a sedimentary deposit or a series of connected deposits which contain fluids (oil, gas, water . . . ). These deposits comprise porous and permeable rocks inside which fluid low. These fluids may possibly accumulate, forming a deposit.

A rock type is a category in which a rock or a soil may be placed, and which defined features such as permeability, porosity, and relative permeability of the phase of a multiphase fluid flowing through the rock. The permeability of the rock determines its capability of letting through the fluid. Porosity is the percentage of empty space inside the rock and gives the volume of fluid which the latter may contain. The relative permeability of a multiphase fluid is the ratio of the effective permeability of that phase to the absolute permeability of the rock, and reflects the fact that the flow of each phase within the rock is inhibited by the presence of the other phase(s). These features are not uniform in a reservoir, but depend on the geological structures which make them up. Thus a goal of characterizing reservoirs is to describe as accurately as possible the petrophysical features of the porous medium forming the reservoir. Also, characterization of a reservoir is based on a description as accurate as possible of the transport of fluids in the reservoir.

To perform this characterization, it is known to build a first fine-scale model representing the geological structure of the reservoir, said model comprising tens of millions of cells, and being populated with indication of a corresponding rock type, and corresponding features such as permeability, porosity, relative permeability values, obtained from experimental data such as drillings performed on site.

The number of cells in these fine-scale models prevents performing any numerical simulation such as a flow simulation, because the numerical simulation time increases exponentially with the number of cells in the model.

Thus, in order to achieve flow simulations within a reasonable computation time, it is common practice to build a coarse-scale simulation model, by grouping cells into meshes and assigning to the meshes an equivalent property calculated from local properties. This is the operation which is called upscaling, and which allows limiting the number of simulated cells and performing faster computations.

Upscaling of porosity is performed by simply computing the arithmetic mean of the porosities of the fine mesh.

Upscaling of permeability can be performed according to the teaching of document U.S. Pat. No. 8,359,184,

In order to perform upscaling of relative permeability of a phase of a fluid, the most frequently used methods are steady-states techniques, because they are quick and simple to implement. Two dominant methods exist which are so-called capillary equilibrium limit method, “CL”, and viscous limit method, “VL”.

The CL method is based on the assumption that capillary forces dominate the flow. According to this method, the relative permeability of a phase of a fluid in a mesh comprising a plurality of cells may be computed, by computing an arithmetic mean of the values of the relative permeabilities of the phase of the fluid in each cell, for a given common value of water saturation—in reservoir modeling the multiphase fluid comprises at least water and gas and/or oil:

$${K}_{r , eq} ( S w ) = \frac{{{Σ}_{i} ( K \cdot {K}_{r} ( S w ) )}_{i}}{{Σ}_{i} {K}_{i}}$$

where i designates a cell of the mesh, K is the permeability of the rock type attributed to the cell, and Kr(Sw)ᵢ is a value of the relative permeability of the phase of the fluid in the cell i for a value S_{w} of water saturation of the fluid.

The VL method is based on the assumption that viscous forces dominate the flow. According to this method, the relative permeability of a phase of a fluid in a mesh comprising a plurality of cells may be computed, by computing an arithmetic mean of the values of the relative permeabilities of the phase of the fluid in each cell, for a given common value of fractional flow. So this method comprises calculating a value Sw corresponding to a determined value of fractional flow fw, and then computing the equivalent relative permeability of a phase of the fluid by:

$${K}_{r , eq} ( S w ( f w ) ) = \frac{{{Σ}_{i} ( K \cdot {K}_{r} ( S w ( f w ) ) )}_{i}}{{Σ}_{i} {K}_{i}}$$

It has been demonstrated in the publication by Jonoud et al. “Validity of Steady-State Upscaling Techniques”, SPE Reservoir Evaluation & Engineering n° 100293, Apr. 2008, that the CL method is only valid for very low values of fluid flow, which is not realistic in most of the exploitation conditions. On the other hand, the VL method can be applied for important flow values and over long distances.

However, both methods exhibit two major drawbacks, which are that they allow neither taking into account the dimension of the meshes in the computation of the equivalent relative permeabilities, nor modeling anisotropy of the reservoir in the values of equivalent relative permeabilities.

### PRESENTATION OF THE INVENTION

In view of the above, the invention aims at providing a method for upscaling values of relative permabilities of a phase of a fluid, wherein upscaled values of relative permeability are directional and depend upon the size of the mesh of the model.

An aim of the invention is in particular to provide a method for computing different equivalent relative permeability values of the phase of a fluid, according to the direction of the flow within the model.

Accordingly, a method for upscaling data of a reservoir model is disclosed, the method being implemented by a computer, and comprising the steps of:
defining a reservoir model comprising a volume of dimensions D_{H}, D_{V} along respectively two distinct directions H,V,
receiving statistical data relative to the volume, comprising:
   relative proportions of at least two rock types, wherein each rock type corresponds to a permeability value and respective curves of relative permeability with water saturation of two phases of a fluid within the rock type, one of the phases being water, and
   a variogram of absolute permeability defined by correlation lengths L_{H}, L_{V}, along the two directions H,V, and,
computing, equivalent relative permeability values of a phase of the fluid within the volume, comprising:
   at least an equivalent relative permeability value according to the first direction H, and
   at least an equivalent relative permeability value according to the second direction V,

wherein each equivalent relative permeability value of a phase of the fluid according to a direction d chosen among H,V is computed based on relative permeability values of the phase of the fluid within each rock type, and on a coefficient depending on the anisotropy of the volume and on non-ergodicity parameters ε_{H}, ε_{V} relative to each direction H,V, the non-ergodicity parameters depending on the volume dimensions along said directions and on the variogram of absolute permeability.

In embodiments, the computing of an equivalent relative permeability value of a phase according to the direction d is based on a mean power formula:

$${K}_{r , eq , d} = \frac{\sqrt[ {ω}_{d}]{{\sum }_{i} {( {K}_{i} \cdot {K}_{r , i} )}^{{ω}_{d}}}}{\sqrt[{ω}_{d}]{{\sum }_{i} {( {K}_{i} )}^{{ω}_{d}}}}$$

where Kᵢ is the permeability value of a rock type i, K_{r,i} is a relative permeability value of a phase of a fluid within the rock type i, K_{r,eq,d} is an equivalent permeability value of the phase of the fluid according to the direction d, and ω_{d} is a power coefficient, applicable for the direction d, defined, for the direction H being a horizontal direction, by:

$${ω}_{H} = \frac{Arctan α}{π - Arctan α}$$

and for the direction V being a vertical direction, by:

ω_{V}=−2ω_{H}+1

where α is the coefficient depending on the anisotropy of the volume and on non-ergodicity parameters, defined by:

$$α = \frac{{L}_{H}}{{L}_{V}} \times \sqrt{\frac{{K}_{V}}{{K}_{H}}} {∈}_{H} {∈}_{V}$$

where

$$\frac{{K}_{V}}{{K}_{H}} and \frac{{L}_{H}}{{L}_{V}}$$

are petrophysical and geostatistical anisotropies depending on the statistical data, and ε_{H}, ϵ_{V} are the non-ergodicity parameters relative respectively to each direction H, V.

In embodiments, the computation of an equivalent relative permeability value of a phase according to a direction is performed for a determined value of water saturation of the phase of the fluid, based on equivalent relative permeability values of the phase within each of the rock types for the same determined value of water saturation.

In embodiments, the computation of an equivalent relative permeability value of a phase according to a direction is performed for a determined value of fractional flow of the phase of the fluid, based on equivalent relative permeability values of the phase of the fluid within each of the rock types for the same determined value of fractional flow.

In embodiments, the method further comprises computing values of equivalent relative permeability of a phase of the fluid according to a first direction for determined values of water saturation, and computing values of equivalent relative permeability of the phase of the fluid according to a second direction for determined values of fractional flow.

In embodiments, each non-ergodicity parameter ε_{d} relative to the direction d is also a function of a mean m and a variance σ of the reservoir absolute permeability values, the mean m and the variance σ depending on the statistical data.

In embodiments, wherein each non-ergodicity parameter ε_{d} relative to a direction d is expressed as a function:

ε_{d}=ƒ(X_{d})

wherein X_{d} depends on the ratio (D_{d}/L_{d}) of a dimension d of the volume to the correlation length of the dimension d, and on the limiting value (D_{d}/L_{d})ₗₒₛₛ of the ratio, and wherein the function

ε_{d}=ƒ(X_{d})

satisfies the condition:

$${lim}_{\frac{{D}_{d}}{{L}_{d}} \to {( \frac{{D}_{d}}{{L}_{d}} )}_{loss}} {∈}_{d} = 1$$

In embodiments, Xd is given by:

$${X}_{d} = 1 - \frac{( \frac{{D}_{d}}{{L}_{d}} )}{{( \frac{{D}_{d}}{{L}_{d}} )}_{loss}}$$

and the function

ε_{d}=ƒ(X_{d})

Is of the polynomial type:

$${ɛ}_{d} = 1 + {\sum }_{i = 1 …} {a}_{i} {X}_{d}^{i}$$

In embodiments, the method comprises determining the distribution of each non-ergodicity parameter ε_{d} using an analytical model.

According to another aspect, a computer program product is disclosed, comprising code instructions for implementing the method according to the above description, when it is executed by a computer.

According to another aspect, a non-transitory computer readable storage medium encoding a computer executable program for executing the method according to the above description.

According to the above method, an equivalent relative permeability value of a phase of a fluid may be computed in two main directions of a model, for each mesh of the model. The method thus takes into account the anisotropy of the reservoir for upscaling relative permeability values.

Furthermore, according to the above method, the upscaled values of relative permeability depend upon the dimensions of the mesh.

### DESCRIPTION OF THE DRAWINGS

Other features and advantages of the invention will be apparent from the following detailed description given by way of non-limiting example, with reference to the accompanying drawings, in which:

FIG. 1 schematically shows the main steps of a method according to an embodiment of the invention.

FIG. 2 schematically shows a device for implementing a method according to an embodiment of the invention.

FIG. 3 shows an example of a reservoir model,

FIG. 4 is a graph of a power coefficient with a ratio LV/DV, where the power coefficient is not computed based on any non-ergodicity coefficient.

FIGS. 5a and 5b show graphs of equivalent relative permeability values along two directions, computed from the relative permeability values of two rock types according to two possible implementations of the method according to the invention.

FIGS. 6a and 6b show graphs of equivalent relative permeability values along a same direction but for two different volume dimensions, computed from the relative permeability values of two rock types according to two possible implementations of the method according to the invention.

### DETAILED DESCRIPTION OF AT LEAST AN EMBODIMENT OF THE INVENTION

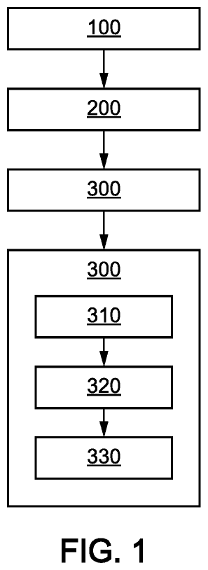

With reference to FIG. 1, the main steps of a method for upscaling data of a reservoir model according to an embodiment of the invention will now be described. In particular, aspects of the disclosure relate to the upscaling of relative permeability values of two fluids, or two phases of a fluid, flowing through a porous medium.

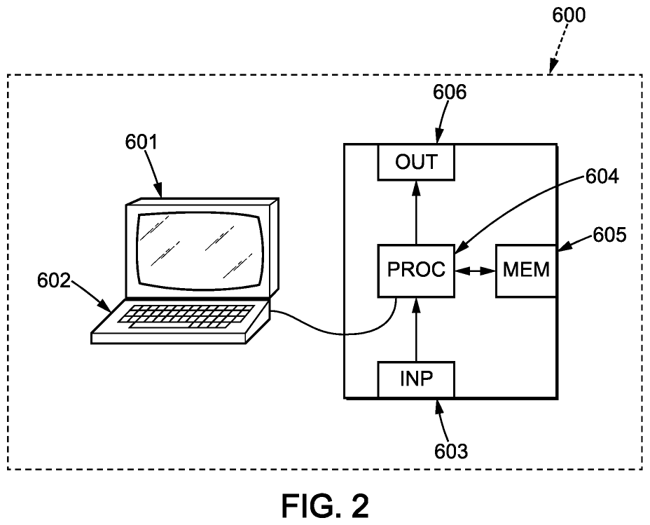

As shown in FIG. 2, the method is implemented by means of a computer 600 comprising a processor 604 adapted to execute a computer program designed for applying the steps of the method. The program comprising instructions for executing the method is stored in a memory 605. The corresponding application typically comprises modules assigned to various tasks which will be described and makes available a suitable user interface, providing input and handling of the required data. The relevant program is for example written in Fortran, if necessary supporting object programming, in C, C++, Java, C#, (Turbo)Pascal, Object Pascal, or more generally stemming from object programming.

The computer may also comprise an input interface 603 for reception of several data, such as statistical data, used for the method according to the invention, and an output interface 606 for outputting the upscaled data of the reservoir model. To ease the interaction with the computer, the latter preferably comprises a display 601 and interface 602 for a user to enter instructions, such as a keyboard. Alternatively the display and interface may be formed by a single Human-Machine Interface allowing such as a tactile screen.

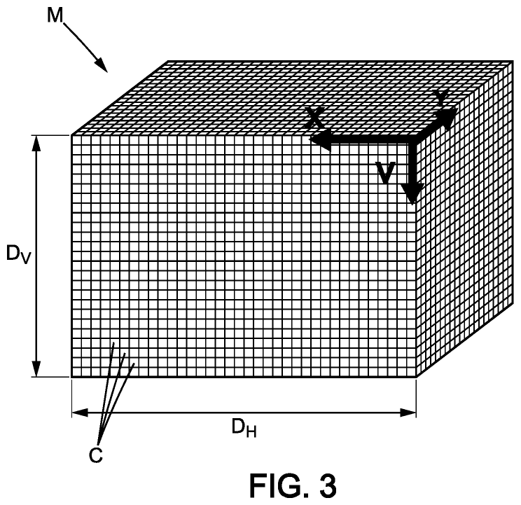

Back to FIG. 1, a first step 100 of the method comprises defining a reservoir model, an example of which is shown in FIG. 3, comprising a volume having dimensions D_{X}, D_{Y}, D_{V} according to three distinct directions X,Y,V, where X and Y are orthogonal directions within a plane and V is a direction orthogonal to that plane. Preferably, the plane is horizontal and the direction V is vertical.

In all that follows, it is considered that D_{X}=D_{Y}=D_{H} where D_{H} denotes a dimension along one of these directions X and Y. It will therefore only be considered two dimensions D_{H}, D_{V} along two typically horizontal H and vertical dimensions V, respectively. The definition of the model preferably comprises a user setting the dimensions D_{H}, D_{V}.

The method then comprises a step 200 of receiving statistical data relative to the volume. The statistical data comprises:
Relative proportions of at least two rock types within the volume, wherein each rock type defines to a porosity value, an absolute permeability value, and also respective curves of relative permeability with water saturation of two phases of a fluid within the rock type, one of the phases being water. The other phase of the fluid may be preferably oil or gas.
The statistical data loaded for the volume also comprises a variogram of absolute permeability within the volume, the variogram being defined by correlation lengths (or spans) L_{H}, L_{V}, along the directions H,V.

The variogram provides a measure of the spatial continuity of a property. The span L_{V} is measured at the well, for example on the log. The span L_{H} is generally estimated by a geologist.

Preferably, the statistical data is stored in the computer's memory and the step of receiving this data is performed by loading a file comprising the desired data.

The method then comprises a step 300 of upscaling the relative permeability values of the two phases of the considered fluid within the volume, i.e. computing, for the whole volume, equivalent relative permeability values for each phase of the considered fluid.

As will be explained in more details below, as the relative permeability of a phase of a fluid is a function of the water saturation within the medium, step 300 may comprise computing at least one value of equivalent relative permeability for each phase of the fluid, corresponding to one value of water saturation. Alternatively, step 300 may comprise computing a number of values of equivalent relative permeability for each of a plurality of values of water saturation.

Additionally, according to the claimed invention, step 300 comprises the computation, for each phase of the fluid, of at least one respective value of equivalent relative permeability value in the volume for each direction H and V.

In this perspective, the invention is based on the hypothesis that there is a correlation between the absolute permeability field and the relative permeability field, i.e. the variogram of absolute permeability is applicable to the relative permeability.

Hence, the method replaces the computation of equivalent relative permeability values within a volume that was performed previously by computation of an arithmetic mean, by the computation of a mean power formula similar to the mean power formula already proposed for the computation of equivalent absolute permeability values, and given by:

$${K}_{r , eq , d} = \frac{\sqrt[ {ω}_{d}]{{\sum }_{i} {( {K}_{i} \cdot {K}_{r , i} )}^{{ω}_{d}}}}{\sqrt[{ω}_{d}]{{\sum }_{i} {( {K}_{i} )}^{{ω}_{d}}}}$$

where:
Kᵢ is the permeability value of a rock type i,
K_{r,i} is a relative permeability value of a phase of a fluid within a rock type i, for instance for a determined value of water saturation within the porous medium,
K_{r,eq,d} is an equivalent permeability value of the same phase of the fluid, according to a direction d, d being either H or V, and for instance for the same value of water saturation within the porous medium, and
ω_{d} is a power coefficient which value depends on the direction d, H or V.

More specifically, each power coefficient ω_{d} according to a direction d is computed based on a coefficient α which depends on the anisotropy within the volume, and on non-ergodicity parameters ε_{H}, ε_{V} relative to each direction H, V and which are derived from the statistical data relative to the volume and from the volume dimensions, as explained in more details below.

Along the horizontal direction H, the power coefficient ω_{H} is defined according to the following formula:

$$\begin{matrix}{ω}_{H} = \frac{Arc tan α}{π - Arc tan α} & ( 1 ) \\ α = \frac{{L}_{H}}{{L}_{V}} \times \sqrt{\frac{{k}_{V}}{{k}_{H}}} {ϵ}_{H} {ϵ}_{V} & ( 2 )\end{matrix}$$

where

$$\frac{{k}_{V}}{{k}_{H}} and \frac{{L}_{H}}{{L}_{V}}$$

are petrophysical and geostatistical anisotropies of the volume, which may be considered as input data and can for instance be received along with the statistical data received at step 200. L_{H}/L_{V} is a ratio of variogram ranges measuring the geostatistical anisotropy, and is greater than 10. The ratio k_{V}/k_{H} measuring the intrinsic petrophysical anisotropy is comprised between 0.01 and 1. This ratio is measured at a small scale, on plugs or logs, or even estimated by a geologist.

Along the vertical direction, the power coefficient is defined according to the following formula:

ω_{V}=−2ω_{H}+1

Ergodicity is defined, at least within the scope of the present invention, as a property expressing the fact that in a process, each sample which may be taken into consideration is also representative of the whole, from a statistical point of view. On the other hand, by non-ergodicity, is meant that a sample is not representative of the whole, always from a statistical point of view. In that case the sample is related to the spatial arrangement of the relative permeability field.

It has been realized that ergodicity conditions are observed for absolute permeability when an investigation volume is sufficiently large. However, at the typical scale of the volume, the ergodicity conditions are not always observed.

Moreover, following the hypothesis according to which the geostatistical properties of the absolute permeability and relative permeability are identical, one can assume that ergodicity conditions determined for absolute permeability within a volume are also applicable for relative permeability, and hence that determining non-ergodicity parameters for absolute permeability from the variogram of absolute permeability allows applying the same non-ergodicity parameters to compute more accurate values of equivalent relative permeabilities of a phase of a fluid. Hence the invention uses such non-ergodicity parameters in the upscaling of equivalent relative permeability values.

Thus the invention makes it possible to take into account the heterogeneities within the volume to compute for the volume and for a given phase of the fluid:
At least an equivalent relative permeability value according to the first direction H, and
At least an equivalent relative permeability value according to the second direction V.

Therefore, the volume is no longer assigned a single equivalent relative permeability value applicable whatever the considered direction of fluid flow, but two values in the two distinct directions H and V. This allows taking into account both the heterogeneities within the volume and the volume dimensions, for computing more accurate equivalent relative permeability values than the prior art methods.

In order to be able to compute such equivalent relative permeability values, step 300 of the method first comprises a substep 310 of determining values of non-ergodicity parameters ε_{V}, ε_{H} of the absolute permeability.

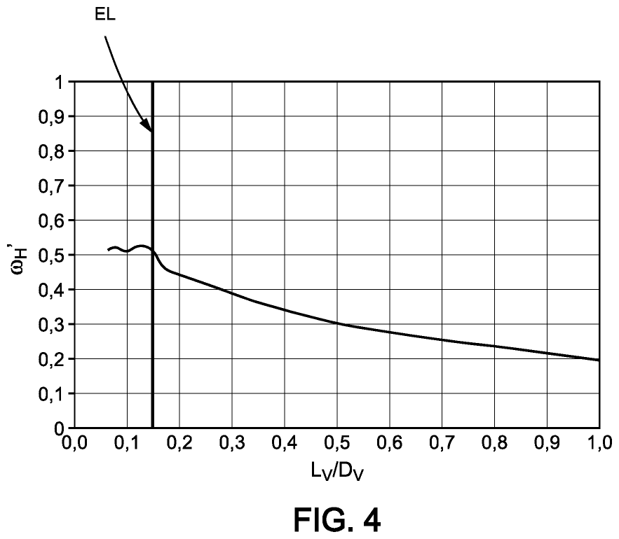

With reference to FIG. 4 is shown the variation, with a ratio L_{V}/D_{V}, of a power coefficient ω_{H}′, in which the coefficient α only takes into account the anisotropies of the volume, but does not take into account non-ergodicity parameters. In other words, the power coefficient shown in this graph is computed with a coefficient α′ denoted:

$${α}^{′} = \frac{{L}_{H}}{{L}_{V}} \times \sqrt{\frac{{K}_{V}}{{K}_{H}}}$$

The same type of curve would have been obtained by replacing L_{V}/D_{V} with L_{H}/D_{H}. It should be noted that this ratio is the reciprocal of the ratio mentioned in the present application, i.e. (D_{V}/L_{V}), respectively (D_{H}/L_{H}), whence the aspect of the curve. It has been ascertained experimentally that the coefficient ω_{H}′ depends on the investigation volume defined by D_{H} and D_{V} and more precisely on (D_{H}/L_{H}) and (DV/L_{V}). From a certain value of these ratios (D_{H}/L_{H}) and (D_{V}/L_{V}), this coefficient ω_{H}′ is constant (as illustrated in FIG. 4). The ergodicity conditions are then found. The limiting values, i.e. below which the ergodicity conditions are no longer observed, are denoted as (D_{H}/L_{H})ₗₒₛₛ and (D_{V}/L_{V})ₗₒₛₛ. Finally below these limiting values, ω_{H}′ does not only depend on the ratios k_{V}/k_{H} and L_{H}/L_{V}, but also on (D_{H}/L_{H}), (D_{V}/L_{V}), (D_{H}/L_{H})ₗₒₛₛ and (D_{V}/L_{V})ₗₒₛₛ, whence the correction obtained by use of non-ergodicity parameters to obtain the coefficient ω_{H}.

It therefore proves to be advantageous to model the non-ergodicity coefficients as functions of (D_{H}/L_{H}) and (D_{V}/L_{V}) as well as of (D_{H}/L_{H})ₗₒₛₛ and (D_{V}/L_{V})ₗₒₛₛ.

In practice, the non-ergodicity parameters may for example be expressed as a function ε_{d}=f(X_{d}), with d being respectively H or V depending on the considered direction, wherein X_{d} depends on the ratio (D_{d}/L_{d}) and on its limiting value (D_{d}/L_{d})ₗₒₛₛ. Taking into account the preceding observations, the function ε_{d}=f(X_{d}) should preferably tend to 1 when (D_{d}/L_{d}) tends to its limiting value (D_{d}/L_{d})loss which is further noted as:

$${lim}_{\frac{{D}_{d}}{{L}_{d}} \to {( \frac{{D}_{d}}{{L}_{d}} )}_{l o s s}} {ɛ}_{d} = 1$$

In particular, a simple scheme is the following:

$${X}_{d} = 1 - \frac{\frac{{D}_{d}}{{L}_{d}}}{{( \frac{{D}_{d}}{{L}_{d}} )}_{loss}}$$

And the function ε_{d}=f(X_{d}) is of the polynomial type, i.e.

$${ɛ}_{d} = 1 + {\sum }_{i} {a}_{i} {X}_{d}^{i}$$

Knowing the span values L_{V} and L_{H}, the ratio k_{V}/k_{H} and the permeability mean m and variance σ as statistical coefficients of the model (provided or inferred from the provided data), the limiting values (D_{H}/L_{H})ₗₒₛₛ and (D_{V}/L_{V})ₗₒₛₛ may be determined by tables obtained experimentally, i.e. the minimum volume size from which ergodicity is observed. These tables may for example be obtained by numerical experimentation, by using a known pressure solver method based on Darcy's law. To do this, the ω_{H}′ coefficient as obtained on a plurality of models each comprising at least one mesh comprising a plurality of cells I populated with various rock types, is plotted against L_{V}/D_{V} or L_{H}/D_{H} or the reciprocal ratio thereof, by resorting to a mean power formula applied for upscaling of absolute permeability:

K_{H}^{ω}^{_{H}}∝ΣK_{H}_{ᵢ}^{ω}^{_{H}}

Where K_{H} is the absolute permeability of the mesh and K_{H}_{ᵢ} is the absolute permeability of each cell. The tables are obtained by plotting the ω_{H}′ coefficient for a plurality of models each having meshes of respectively different dimensions.

Various distributions of the non-ergodicity parameters ε_{V}, ε_{H} (i.e. various coefficients of the polynomial function given above) may be obtained according to either optimistic, median or pessimistic estimation of these parameters. The relevant estimations are provided by known analytical tools.

Then, for each hypothesis regarding the distribution of the non-ergodicity parameters, it is possible to compute from the values of the (D_{d}/L_{d}) and (D_{d}/L_{d})ₗₒₛₛ ratios, respective values of ε_{V} and ε_{H}.

Once various values of ε_{V}, respectively ε_{H} have been obtained according to different estimations of these parameters and the functions described above, step 320 of the method comprises computing the coefficient α and respective power coefficients ω_{V}, ω_{H}, from the non-ergodicity coefficients, according to equations (1) and (2) given above.

The computation 330 of at least one value of equivalent relative permeability of a phase of a fluid according to one of the directions H and V for the volume may then be performed according to the so-called capillary limit method or viscous limit method, depending on the assumptions done on the reservoir model.

If it is assumed that capillary forces dominate the flow for a given direction d, then the capillary limit method may be implemented, and in that case an equivalent relative permeability value of a phase of the fluid according to the direction d is performed for a determined value of water saturation S_{w} of the phase of the fluid. For the given water saturation S_{w} of the phase of the fluid, the relative permeability values K_{r,i}(S_{w}) of the phase of the fluid within the rock types i are determined and an equivalent relative permeability value in the direction d is computed as:

$${K}_{r , eq , d} ( {S}_{w} ) = \frac{\sqrt[{ω}_{d}]{{\sum }_{i} {( {K}_{i} . {K}_{r , i} ( {S}_{w} ) )}^{{ω}_{d}}}}{\sqrt[{ω}_{d}]{{\sum }_{i} {( {K}_{i} )}^{{ω}_{d}}}}$$

If on the other hand it is assumed that viscous forces dominate the flow for a direction d, then the viscous limit method may be implemented, and in that case an equivalent relative permeability value of a phase of the fluid according to the direction d is performed for a determined value of fractional flow of the phase of the fluid. For the given value of fraction flow F of the phase of the fluid, the relative permeability values K_{r,i}(F) of the fluid within the rock types I are determined and an equivalent relative permeability value in the direction d is computed as:

$${K}_{r , eq , d} ( F ) = \frac{\sqrt[{ω}_{d}]{{\sum }_{i} {( {K}_{i} . {K}_{r , i} ( F ) )}^{{ω}_{d}}}}{\sqrt[{ω}_{d}]{{\sum }_{i} {( {K}_{i} )}^{{ω}_{d}}}}$$

In both cases it is to be noted that, as explained above there may be several values of ω_{d} according to the various values of ε_{d} which could be computed according to different estimations, and hence several values of equivalent relative permeability values may be obtained for a common S_{w} or F, and for the direction d.

Advantageously, as the method allows computing respective values of equivalent relative permeability for the two directions H and V, it is possible to compute an equivalent relative permeability value for a first direction according to one of the viscous limit method and the capillary limit method, and to compute an equivalent relative permeability for a second direction according to the other method, if this allows a more accurate representation of the reservoir.

The computed values of K_{r,eq,d} for the volume may then be stored in the memory.

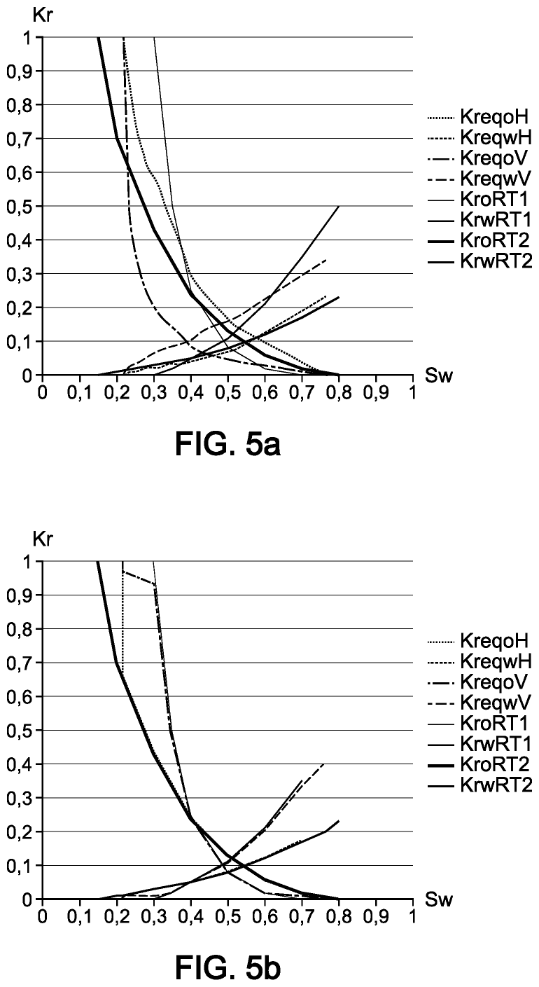

With reference to FIGS. 5a and 5b are shown two graphs, each displaying:
Curves of relative permeability respectively of oil and water with water saturation in a rock type 1 RT₁ and a rock-type 2 RT₂, respectively denoted KroRT1, KrwRT1, KroRT2, KrwRT2, where o stands for oil and w stands for water.
Curves of equivalent relative permeability respectively of oil and water with water saturation in the volume, according to directions H and V, respectively denoted KreqoH, KreqwH, KreqoV, KreqwV.
In FIG. 5a, the curves of equivalent relative permeability are computed with the viscous limit method (i.e. based on relative permeability values for RT₁ and RT₂ determined for common values of water saturation), whereas in FIG. 5b the curves are computed with the capillary limit method (i.e. based on relative permeability values for RT₁ and RT₂ determined for common values of fractional flow).

These graphs allow underlining the influence both of the direction H or V, and of the computation method, in the computation of the equivalent relative permeability.

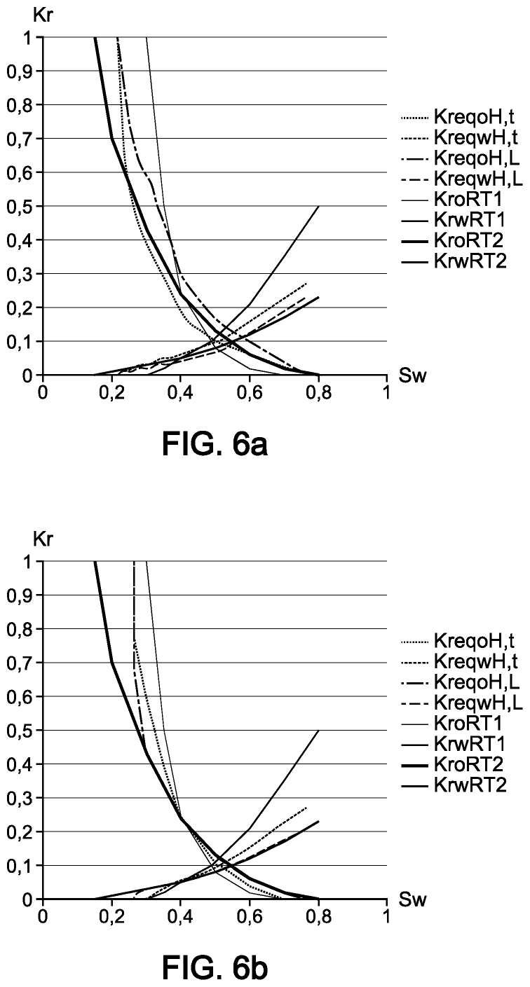

Moreover, with reference to FIGS. 6a and 6b are shown two graphs, each displaying:
Curves of relative permeability respectively of oil and water with water saturation in a rock type 1 RT₁ and a rock-type 2 RT₂, respectively denoted KroRT1, KrwRT1, KroRT2, KrwRT2
Curves of equivalent relative permeability respectively of oil and water with water saturation in the volume, according to direction H, computed for a volume having two different dimensions along H, respectively denoted KreqoH,t, KreqwH,t, KreqoH,L, KreqwH,L, where t designates the thinner dimension along H and L designates the larger dimension along H.
In FIG. 6a, the curves of equivalent relative permeability are computed with the viscous limit method (i.e. based on relative permeability values for RT₁ and RT₂ determined for common values of water saturation), whereas in FIG. 6b the curves are computed with the capillary limit method (i.e. based on relative permeability values for RT1 and RT2 determined for common values of fractional flow).

These graphs also underline the impact of the choice of the method in the computation of the equivalent permeability value, but also underline the importance of taking into account the volume dimension according to the direction for which the equivalent relative permeability value is computed.

1. A computer-implemented method for upscaling data of a reservoir model, comprising:
defining a reservoir model comprising a volume of dimensions D_{H}, D_{V} along respectively two distinct directions H,V,
receiving statistical data relative to the volume, comprising:
relative proportions of at least two rock types, wherein each rock type corresponds to a permeability value and respective curves of relative permeability with water saturation of two phases of a fluid within the rock type, one of the phases being water, and
a variogram of absolute permeability defined by correlation lengths L_{H}, L_{V}, along the two directions H,V, and,
computing, equivalent relative permeability values of a phase of the fluid within the volume, comprising:
at least an equivalent relative permeability value Kr_{eq,H} according to the direction H, and
at least an equivalent relative permeability value Kr_{eq,V} according to the direction V,
wherein each equivalent relative permeability value of a phase of the fluid according to a direction d chosen among H,V is computed based on relative permeability values of the phase of the fluid within each rock type, and on a coefficient depending on the anisotropy of the volume and on non-ergodicity parameters ε_{H}, ε_{V} relative to each direction H,V, the non-ergodicity parameters depending on the volume dimensions along said directions and on the variogram of absolute permeability.

2. A method according to claim 1, wherein the computing of an equivalent relative permeability value of a phase according to the direction d is based on a mean power formula:
$${K}_{r , eq , d} = \frac{\sqrt[{ω}_{d}]{{\sum }_{i} {( {K}_{i} . {K}_{r , i} )}^{{ω}_{d}}}}{\sqrt[{ω}_{d}]{{\sum }_{i} {( {K}_{i} )}^{{ω}_{d}}}}$$
where Kᵢ is the permeability value of a rock type i, K_{r,i} is a relative permeability value of a phase of a fluid within the rock type i, K_{r,eq,d} is an equivalent permeability value of the phase of the fluid according to the direction d, and ω_{d} is a power coefficient, applicable for the direction d, defined, for the direction H being a horizontal direction, by:
$${ω}_{H} = \frac{Arc tan α}{π - Arc tan α}$$
and for the direction V being a vertical direction, by:
ω_{V}=−2ω_{H}+1
where α is the coefficient depending on the anisotropy of the volume and on non-ergodicity parameters, defined by:
$${α}^{′} = \frac{{L}_{H}}{{L}_{V}} \times \sqrt{\frac{{K}_{V}}{{K}_{H}}} {ϵ}_{H} {ϵ}_{V}$$
where
$$\frac{{k}_{V}}{{k}_{H}} and \frac{{L}_{H}}{{L}_{V}}$$
are petrophysical and geostatistical anisotropies depending on the statistical data, and ε_{H}, ϵ_{V} are the non-ergodicity parameters relative respectively to each direction H, V.

3. A method according to claim 2, wherein the computation of an equivalent relative permeability value of a phase according to a direction is performed for a determined value of water saturation of the phase of the fluid, based on equivalent relative permeability values of the phase within each of the rock types for the same determined value of water saturation.

4. A method according to claim 2, wherein the computation of an equivalent relative permeability value of a phase according to a direction is performed for a determined value of fractional flow of the phase of the fluid, based on equivalent relative permeability values of the phase of the fluid within each of the rock types for the same determined value of fractional flow.

5. A method according to claim 3, comprising computing values of equivalent relative permeability of a phase of the fluid according to a first direction for determined values of water saturation, and computing values of equivalent relative permeability of the phase of the fluid according to a second direction for determined values of fractional flow.

6. A method according to claim 1, wherein each non-ergodicity parameter ε_{d} relative to the direction d is also a function of a mean m and a variance σ of the reservoir absolute permeability values, the mean m and the variance σ depending on the statistical data.

7. A method according to claim 1, wherein each non-ergodicity parameter εd relative to a direction d is expressed as a function:
ε_{d}=ƒ(X_{d})
wherein X_{d} depends on the ratio (D_{d}/L_{d}) of a dimension d of the volume to the correlation length of the dimension d, and on the limiting value (D_{d}/L_{d})ₗₒₛₛ of the ratio, and wherein the function
ε_{d}−ƒ(X_{d})
satisfies the condition:
$${lim}_{\frac{{D}_{d}}{{L}_{d}} \to {( \frac{{D}_{d}}{{L}_{d}} )}_{l o s s}} {ɛ}_{d} = 1$$

8. A method according to claim 7, wherein
$${X}_{d} = 1 - \frac{( \frac{{D}_{d}}{{L}_{d}} )}{{( \frac{{D}_{d}}{{L}_{d}} )}_{l o s s}}$$
And the function
ε_{d}−ƒ(X_{d})
Is of the polynomial type:
$${ɛ}_{d} = 1 + {\sum }_{i = 1 …} {a}_{i} {X}_{d}^{i}$$

9. A method according to claim 8, comprising determining the distribution of each non-ergodicity parameter ε_{d} using an analytical model.

10. A computer program product, comprising code instructions for implementing the method according to claim 1, when it is executed by a computer.

11. A non-transitory computer readable storage medium encoding a computer executable program for executing the method according to claim 1.

12. A method according to claim 4, comprising computing values of equivalent relative permeability of a phase of the fluid according to a first direction for determined values of water saturation, and computing values of equivalent relative permeability of the phase of the fluid according to a second direction for determined values of fractional flow.
